(19) United States
(12) Patent Application Publication
(10) Pub. No.: US 2013/0195275 A1
(43) Pub. Date: Aug. 1, 2013

(54) RESOLVING UE REFERENCE SIGNAL PORT AMBIGUITIES

(71) Applicants: Tommi T. KOIVISTO, Espoo (FI); Tero Kuosmanen, Tampere (FI); Timo E. Roman, Espoo (FI)

(72) Inventors: Tommi T. KOIVISTO, Espoo (FI); Tero Kuosmanen, Tampere (FI); Timo E. Roman, Espoo (FI)

(73) Assignee: Renesas Mobile Corporation

(21) Appl. No.: 13/431,220

(22) Filed: Mar. 27, 2012

(30) Foreign Application Priority Data
Jan. 27, 2012 (GB) 1201379.3

(51) Int. Cl. H04W 72/04; H04K 1/04

(52) U.S. Cl. 380/287; 370/329

(57) ABSTRACT

A resource allocation for a specific user equipment (UE) is encoded using an encoding scheme that identifies a specific antenna port from among a plurality of antenna ports; and the encoded resource allocation is output to the specific antenna port for transmission to the specific UE. The UE blindly detects its control channel and determines its resource allocation by decoding the control channel using a decoding scheme that identifies a specific antenna port from among the plurality of transmit antenna ports. In various embodiments, the scheme is in scrambling or masking (using an ID of the antenna port or UE); by the order of bits when encoding, port specific mapping constellations, and adding bits that give the port index.

### TECHNICAL FIELD

The exemplary and non-limiting embodiments of this invention relate generally to wireless communication systems, methods, devices and computer programs; and more specifically relate to arranging control signaling such that a UE receiving a control channel (such as an E-PDCCH in the LTE system) will not successfully decode it using an incorrect port configuration the UE assumes for the eNB.

### BACKGROUND

Abbreviations used in this description and/or in the referenced drawings are defined below following the Detailed Description section.

These teachings relate to substantially reducing the relatively high probability that currently exists for a UE to decode the E-PDCCH using an incorrect assumption of the eNB's antenna port configuration, yet the decoding still passes the CRC and so the UE believes it has the correct port configuration. The problem arises in part because the E-PDCCH supports UE-specific RSs which are precoded and so the eNB's antenna port configuration for the E-PDCCH is not necessarily fixed, whereas the conventional PDCCH uses cell-wide (broadcasted) CRSs which are not precoded and the eNB's port configuration for transmitting it is static in the cell.

For the UE's blind decoding of the E-PDCCH each decoding attempt assumes a certain resource mapping and antenna port(s) for a given E-PDCCH format (size). If the CRC passes for a given blind decoding attempt the UE assumes the decoding is successful. But FIG. 1 illustrates that passing the CRC does not necessarily mean that the antenna port configuration assumed for the ‘successful’ decoding of the E-PDCCH was an accurate description of what the eNB actually used to transmit it. There exist some situations (for example under MU-MIMO scheduling) where the control message could be successfully received with two different assumptions on the utilized antenna port. When receiving from the wrong antenna port, the UE-RS cover code can be de-spread with an incorrect cover code corresponding to a different antenna port, for example the UE should normally decode antenna port AP7 with the cover code [+1,+1] but may attempt decoding instead AP8 with the cover code [+1,−1]. Despite the very low quality of the resulting channel estimate, the robust channel coding (low coding rate) together with QPSK modulation used for control information makes it possible to successfully decode the E-PDCCH using an incorrect assumption of the antenna port the eNB assigned to the UE for that transmission.

FIG. 1 is a diagram of block error rate BLER (vertical axis) on a control channel versus signal to noise ratio SNR (horizontal axis) showing disparity between decoding with a correct demodulation RS port selection (solid lines) and an incorrect port selection (dashed lines). The inventors have conducted a link level study showing there is roughly a 15% probability of successfully decoding the control message using an incorrect assumption of the antenna port in a MU-MIMO configuration. The UEs in the simulation from which the FIG. 1 data was obtained were assigned with the same UE-RS sequences, in order to preserve the orthogonality between the antenna ports. Significantly, it is not possible to assign the UEs with different UE-RS sequences without losing the orthogonality of the antenna port multiplexing. It does not appear that the 15% mis-detection probability can be appreciably decreased by changing the multi-user pairing or the UE-RS sequences.

A mis-detection probability on the order of 15% is substantial, meaning the UE's blind decoding cannot guarantee that the E-PDCCH antenna port is unambiguously detected. This problem is exacerbated when other information is implicitly linked to the antenna port configuration for transmitting the E-PDCCH. For example, the resource allocation on the PUCCH on which the UE is supposed to transmit its ACK/NACK may depend on the antenna port used to transmit the E-PDCCH. Similar implicit linkage from the PDCCH is already in use for Release 8 ACK/NACK resource allocation on the PUCCH, but as noted above the port configuration in Releases 8-10 is fixed so the potential for mis-detection is negligible. But FIG. 1 shows the mis-detection potential for the E-PDCCH is not slight. If the antenna port is mis-detected the UE would transmit its ACK/NACK on the wrong channel, causing interference to some other UE as well as causing the eNB to miss the UE's ACK/NACK transmission since it is not on the correct PUCCH resource. The uplink ACK/NACK resource allocation is but one example of information that could be linked to the antenna port used for the E-PDCCH; other information can be implicitly linked to that port configuration and may be in further development of LTE Release 11 or later since all aspects of the E-PDCCH are not yet resolved in the 3GPP.

What is needed in the art is a way for the UE to avoid UE-RS port misdetection during the E-PDCCH blind decoding process.

### SUMMARY

In a first exemplary aspect of the invention there is a method comprising: encoding a resource allocation for a specific user equipment using an encoding scheme that identifies a specific antenna port from among a plurality of antenna ports; and outputting the encoded resource allocation to the specific antenna port for transmission to the specific user equipment.

In a second exemplary aspect of the invention there is an apparatus comprising at least one processor and at least one memory storing a computer program. In this aspect the at least one memory with the computer program is configured with the at least one processor to cause the apparatus to perform at least: encoding a resource allocation for a specific user equipment using an encoding scheme that identifies a specific antenna port from among a plurality of antenna ports; and outputting the encoded resource allocation to the specific antenna port for transmission to the specific user equipment.

In a third exemplary aspect of the invention there is a computer readable memory tangibly storing a computer program executable by at least one processor, the computer program comprising: code for encoding a resource allocation for a specific user equipment using an encoding scheme that identifies a specific antenna port from among a plurality of antenna ports; and code for outputting the encoded resource allocation to the specific antenna port for transmission to the specific user equipment.

In a fourth exemplary aspect of the invention there is a method comprising: blindly detecting a control channel for a specific user equipment; and determining a resource allocation for the specific user equipment by decoding the control channel using a decoding scheme that identifies a specific antenna port from among a plurality of transmit antenna ports.

In a fifth exemplary aspect of the invention there is an apparatus comprising at least one processor and at least one memory storing a computer program. In this aspect the at least one memory with the computer program is configured with the at least one processor to cause the apparatus to perform at least: blindly detecting a control channel for a specific user equipment; and determining a resource allocation for the specific user equipment by decoding the control channel using a decoding scheme that identifies a specific antenna port from among a plurality of transmit antenna ports.

In a sixth exemplary aspect of the invention there is a computer readable memory tangibly storing a computer program executable by at least one processor, the computer program comprising: code for blindly detecting a control channel for a specific user equipment; and code for determining a resource allocation for the specific user equipment by decoding the control channel using a decoding scheme that identifies a specific antenna port from among a plurality of transmit antenna ports.

These and other embodiments and aspects are detailed below with particularity.

### BRIEF DESCRIPTION OF THE DRAWINGS

FIG. 1 is a diagram of block error rate BLER on a control channel versus signal to noise ratio SNR showing disparity between decoding with a correct demodulation reference signal port selection (solid lines) and an incorrect port selection (dashed lines).

FIG. 2 illustrates two constellations which different antennas use for their respective bit to QPSK mapping according to an exemplary fourth embodiment of the invention.

FIG. 3 is a logic flow diagram that illustrates from the perspective of the network/eNB the operation of a method, and a result of execution of computer program instructions embodied on a computer readable memory, in accordance with an exemplary embodiment of this invention.

FIG. 4 is a logic flow diagram that illustrates from the perspective of the UE the operation of a method, and a result of execution of computer program instructions embodied on a computer readable memory, in accordance with an exemplary embodiment of this invention.

FIG. 5 is a simplified block diagram of a UE and an eNB which are exemplary electronic devices suitable for use in practicing the exemplary embodiments of the invention.

### DETAILED DESCRIPTION

The following examples are in the specific context of the LTE/LTE-Advanced systems (for example, Release 11 and later) but these teachings are more broadly applicable to any wireless radio system which employs radio resource grants from the network to the UEs. These examples consider only a single UE but it will be understood the description applies for all such UEs being scheduled for radio resources according to the teachings described for one UE.

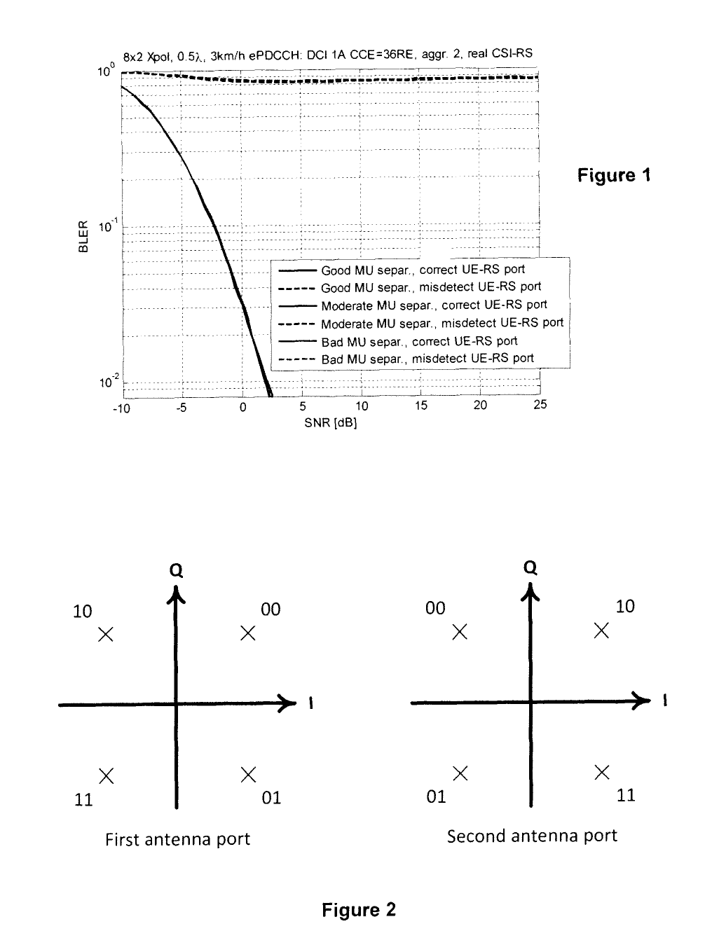

Following is a more detailed exposition of the problem summarized in the background section above which FIG. 1 quantifies. Release 10 of the 3GPP LTE specification includes features related to downlink and uplink MIMO, relays, bandwidth extension via carrier aggregation and enhanced inter-cell interference coordination (eICIC). While Release 10 is finalized, ongoing development of the Release 11 specifications include downlink MIMO enhancements, one portion of which is downlink control signaling enhancements. Current downlink control signaling is based on common reference signals (CRS) which are not precoded and are broadcasted over the entire cell. When multiple antennas are in use, transmit diversity is used. Specifically, space-frequency block code (SFBC) is used for the case of 2 transmit antennas and SFBC-frequency switched transmit diversity (FSTD) is used for the case of 4 transmit antennas. Mapping of the control channels to resource elements (REs) is fixed and based on the cell ID. The 3GPP is working to enhance the physical downlink control channel (PDCCH) such that more advanced multi-antenna schemes could be used, such as closed-loop single-user (SU-) MIMO or multi-user (MU-) MIMO or even coordinated multi-point transmission (CoMP). Another goal is to allow more flexibility in mapping to the resource elements in order to improve inter-cell interference coordination possibilities for control channels, which may provide benefits when enhanced inter-cell coordination (eICIC) techniques are in use in a heterogeneous network environment.

In LTE Releases 8-10, the downlink control information (DCI) is transmitted on the physical downlink control channel (PDCCH) which gives the UE its UL and DL resource allocations/assignments for data. The PDCCH is transmitted on the same set of antenna ports as the physical broadcast channel (PBCH), which is why the eNB's antenna port configuration for sending the PDCCH is cell-specific and static. Specifically, the PDCCH transmission mode is either single-antenna port transmission or transmit diversity, depending on the number of antenna ports configured at the eNB. Mapping of logical antenna ports to physical transmit antennas is standard transparent and implementation specific. The radio channel frequency response for the UE's demodulation of the PDCCH is estimated from the CRSs associated to the eNB's antenna ports.

LTE Release-11 adds a new scheduling channel E-PDCCH, which will partly resemble the relay-PDCCH (R-PDCCH) specified in Release 10 for relay nodes in that it will most likely support UE-specific reference signals (UE-RS) and be mapped to the PDSCH region of the subframe. It will be possible to transmit the E-PDCCH with spatial multiplexing using antenna ports with UE-RS. The E-PDCCH is expected to support multi-user MIMO, and/or (in contrast to the R-PDCCH) to multiplex DCIs to several UEs within one PRB pair. While the reader may imply that the term UE-specific RS means each is to be used by a single UE, note this is not necessary as in principle nothing forbids the eNB to configure multiple UEs with the same RS in which case also UE-specific RS could be in fact shared by multiple UEs. The key distinction is that CRSs are cell-wide and UE-RSs are UE specific even if they are not UE unique.

The CRSs are not precoded whereas the UE-RSs are, and the underlying precoding decisions have an effect on the antenna port that is used for the transmission of the E-PDCCH to a given UE. For example, the eNB may make one type of precoding/scheduling decision when it uses MU-MIMO and another for SU-MIMO. Therefore the antenna port configuration of the E-PDCCH transmission cannot be static to preserve precoding/scheduling flexibility at the eNB. Therefore the UE must use blind decoding attempts in order to find the correct antenna port (among multiple possible UE-RS ports) that the eNB used for transmitting the E-PDCCH to this specific UE. Similarly, if multiple DCIs are mapped to the same PRB pair, the UE may have to blindly search for the correct phase reference for demodulation among multiple possible UE-RS ports.

In the UE's blind decoding it assumes that its E-PDCCH is carried by a certain block of resource elements, according to UE's search space. The UE assumes that part of the resource elements carry the precoded UE-specific RSs, and also must assume a certain antenna port (or multiple ports if antenna diversity or spatial multiplexing is utilized) to create a channel estimate. This antenna port assumption affects how the resource elements are selected and how the orthogonal cover code of the UE-RS is de-spread. The channel estimate is used for demodulating the expected E-PDCCH resource elements.

LTE Release 10 specifications provide at section 5.3.3.2 of 3GPP TS36.212, MULTIPLEXING AND CHANNEL CODINg (Release 10), v10.3.0 (2011-09) that the CRC of the PDCCH is scrambled with the UE identity, specifically the UE's radio network temporary identifier RNTI. But the PDCCH uses CRSs and not UE-specific RSs as does the E-PDCCH. That same specification also provides at section 5.3.1.1 that the CRC of the master information blocks (MIBs) is scrambled with a bit mask which depends on the number of transmit antenna ports at the eNB. But the MIBs are broadcast over the PBCH and so are common throughout the whole cell, unlike the E-PDCCH which gives to specific UEs their resource allocations.

Prior to the bit-masking noted above being adopted in LTE Release 10, following are a few of the competing suggestions for addressing PBCH mis-detection. Document R1-074642 by Nortel entitled THE RELIABILITY IMPROVEMENT OF THE BLIND DETECTION OF THE ANTENNA CONFIGURATION (3GPP TSG-RAN1 meeting #51; Jeju Island, South Korea; 5-9 Nov. 2007) offered four different approaches to mitigate mis-detection of the PBCH: change the resource element mapping of the PBCH depending on the number of transmit antennas; apply a scrambling sequence which depends on the number of transmit antennas; modify the Alamouti transmission format to reduce similarities between the different transmit diversity schemes; and use some type of reliability measure in the decoding of the PBCH (for example, different versions of the PBCH corresponding to the different transmit antenna configurations are decoded and some decoding reliability measurement is used to select one having the strongest reliability).

Document R1-080324 by Nokia Siemens Networks, Nokia, China Mobile and Huawei entitled ISSUES WITH PBCH-BASED BLIND ANTENNA CONFIGURATION DETECTION (3GPP TSG-RAN1 meeting #51bis; Sevilla, Spain; 14-18 Jan. 2008) suggested CRC masking of the PBCH that depends on the antenna configuration; and a new mapping of the PBCH to the resource elements (starting in the first OFDM symbol of the second slot).

Document R1-080944 by Nokia Siemens Networks and Nokia entitled CRC MASK SELECTION FOR PBCH (3GPP TSG WG1 meeting #52; Sorrento, Italy; 11-15 Feb. 2008) considered how the CRC mask would be selected when the CRC mask of the PBCH depends on the antenna configuration.

United States Patent Application Publication 2009/0176463 entitled METHOD AND APPARATUS FOR CONVEYING ANTENNA CONFIGURATION INFORMATION discloses how to convey information regarding the antenna configuration and/or the transmission diversity scheme to a mobile device recipient. In particular, such information can be conveyed by mapping a PBCH within a sub-frame so as to include CRSs indicative of different antenna configurations or transmission diversity schemes or by CRC masking.

United States Patent Application Publication 2010/0323637, entitled METHOD AND APPARATUS FOR CONVEYING ANTENNA CONFIGURATION INFORMATION VIA MASKING describes that the set of CRC masks can be determined based upon the Hamming distances between the masks and bit diversities between the masks, where each of the masks within the set is associated with an antenna configuration and a transmission diversity scheme.

And United States Patent Application Publication 2007/0135161 entitled SIGNALING SUPPORT FOR ANTENNA SELECTION USING SUBSET LISTS AND SUBSET MASKS associates antenna masks to the usage of virtual antennas/beams existing within a cell. The base station may select and signal to the mobile unit a subset of virtual antennas/beams out of a total available number of virtual antennas/beams. The base station will make use of the antennas/beams belonging to this subset for communicating downlink with the mobile unit and in turn the mobile unit transmits uplink channel quality reports for those antennas/beams only. An antenna subset mask is used for the associated signaling to the mobile unit indicting which antenna/beam is active or not.

The problem resolved by certain implementations of these teaching, namely avoiding or at least severely minimizing the opportunity for a UE to detect the E-PDCCH under an erroneous assumption on the antenna setup at eNB, is not directly addressed by any of the above references. Those documents deal with mis-detection a common/broadcast channel (PBCH) under an erroneous assumption on the total number of CRS ports which are cell-specific, whereas the issue detailed above for Release 11 concerns UE-specific RSs and the mis-direction to be avoided arises from a potential erroneous assumption on a UE-specific antenna port (index) for E-PDCCH demodulation. The solutions detailed below introduce a linkage between a UE-specific antenna port information and the UE's resource assignment, whereas in the above solutions for the PBCH the linkage is between the total number of antenna ports at the eNB, and some also combine that with a transmit diversity scheme. The exemplary solutions detailed below applies to UE-specific dedicated antenna ports, whereas the above references deal with cell-specific (cell-wide) antenna ports. All of these differences arise from the fact that the above documents concern common (broadcast) channels used for communicating with all the mobile terminals associated to the base station, whereas the mis-direction problem solved by exemplary implementations of these teachings concern the E-PDCCH which is a dedicated (i.e. UE-specific) control channel.

Additionally, unlike the solutions in the above documents which are only proposed for SU-MIMO transmissions, exemplary embodiments of these teachings applied for the E-PDCCH is relevant for both SU-MIMO and MU-MIMO as well as for coordinated multi-point transmission (CoMP). Also, United States Patent Application Publication 2007/0135161 concerns the configuration of virtual antennas whereas these teachings concern the actual antenna port configuration which is used for demodulation.

Exemplary embodiments of these teachings introduce antenna port-specific encoding/detection schemes for the downlink control information (DCI) such that it is not possible to mis-detect the E-PDCCH using any other antenna port than the one it is associated to. Below are detailed five distinct ways for this antenna port-specific encoding, and for convenience those five are summarized here. In a first embodiment an antenna port-dependent variable is added in the E-PDCCH scrambling sequence initialization value. In a second embodiment there is antenna port-specific masking of the E-PDCCH CRC in addition to UE-ID masking noted above. In a third embodiment there is antenna port-specific interleaving. For example, in one implementation of this third embodiment the encoded E-PDCCH bits are interleaved or rearranged in an antenna port-specific way. In another implementation of this third embodiment there is antenna port-specific symbol interleaving or resource mapping of the E-PDCCH (mapping of the E-PDCCH to resource elements). In a fourth embodiment the mapping of bits to the QPSK constellation is antenna port-specific. And in a fifth embodiment the eNB sends explicit signaling to inform the UE what antenna port configuration it used for the E-PDCCH, namely the eNB adds an antenna port confirmation bit to the DCI format conveyed by the E-PDCCH.

Before detailing these five embodiments in particular, consider first the process the eNB follows in constructing the E-PDCCH for transmission. The DCI to be transmitted by the eNB consists of a length-N bit sequence b₀, . . . b_{N-1} (this is the UE's payload in the E-PDCCH). First, the eNB attaches a CRC of length L (L=16 in current LTE) to the DCI payload. Typically the CRC is masked with the UE ID (C-RNTI) of the UE such that the UE can identify which DCI is intended for it. As a result of the CRC attachment, the bit sequence b₀, . . . b_{N-1+L} is the bit sequence that is input to channel coding. This sequence is channel coded (in LTE with a convolutional code) to get a length-M coded bit sequence c₀, . . . c_{M-1}. This coded bit sequence is then scrambled with a scrambling sequence s₀, . . . , s_{M-1} to result in the sequence yₖ=(cₖ+sₖ) mod 2. Finally, the scrambled bit sequence is input into the eNB's modulator which maps the bits to modulation symbols (QPSK in LTE).

According to the various embodiments detailed herein, at least one of the above steps is done in an antenna port-specific manner.

According to the first embodiment, the scrambling sequence s₀, . . . , s_{M-1} is generated using an initialization value that depends on the antenna port. For example, currently for PDCCH the scrambling sequence is initialized with cᵢₙᵢₜ=└nₛ/2┘2⁹+N_{ID}^{cell}. One exemplary modification to make this antenna port-specific is to add an antenna port identifier in the initialization process, such as cᵢₙᵢₜ=└nₛ/2∃2⁹+N_{ID}^{cell}+N_{ID}^{ap}. In the above equations, cᵢₙᵢₜ is the initial element of the scrambling sequence, nₛ is the slot number within a radio frame, N_{ID}^{cell} is the physical layer cell identity, and N_{ID}^{ap} is the identifier of a specific antenna port.

According to the second embodiment, the antenna port identifier is embedded in the CRC by masking (scrambling) the CRC further with an antenna port identifier. If we denote the CRC sequence masked only with the UE ID as xₖ, k=0, . . . , 15, then after antenna port-specific masking sequence aₖ the CRC is zₖ=(xₖ+aₖ) mod 2.

According to the third embodiment, the coded and scrambled bits yₖ are interleaved or otherwise rearranged in a (different) antenna port-specific order. If we assume an original/conventional bit order for the coded bits yₖ for the first antenna port is retained in this third embodiment, then the antenna-specific encoding can re-arrange the coded bits for the second antenna port so they are transmitted in a reverse order (or in any other antenna port-specific order where the bit order differs from that used for the first antenna port). Or alternatively the coded bits for the second antenna port can be interleaved such as by writing them one row at a time to a buffer memory having K columns then reading out the buffered bits one column at a time.

The interleaving/rearranging in this third embodiment may also be done to the coded bit sequence cₖ before applying the scrambling code. The bit re-arrangement may also be done on the symbol level after the eNB's modulator (QPSK symbols in LTE). This is a bit re-arrangement because symbol-level re-arranging is a re-arrangement of the bits in batches of q bits, where q is the modulation order (q=2 for QPSK).

The fourth embodiment does the bit-to-symbol mapping in an antenna port-specific way and one example of this is illustrated at FIG. 2. The constellation at the left side shows the bit-to-QPSK mapping currently used in conventional LTE and in this example that mapping is used for the first antenna port. The constellation at the right side of FIG. 2 shows bit-to-QPSK mapping used for the second antenna port according to this example of the fourth embodiment. As is evident from the right side constellation at FIG. 2, it is also possible in this fourth embodiment to preserve the Gray coding-based bit mapping, in which each sequential bit value differs by only a single bit.

According to the fifth embodiment, the DCI payload b₀, . . . , b_{N}₋₁ contains a field that explicitly indicates the used antenna port. For example, if there are only two possible antenna ports the indication may be as little as one bit, or if there is a total of four antenna ports the indication may be as few as two bits.

According to exemplary embodiment of the invention from the perspective of the UE, the UE searches for a downlink control information transmission as follows. It attempts blind detection from each possible search space location. The UE's search space location is defined by a combination of certain E-PDCCH resource mapping and antenna port. When detecting the E-PDCCH from a given search space location, the UE first estimates the channel from the corresponding antenna port, and equalizes the signal to obtain the received symbol stream. From the received symbols, the UE then demodulates and/or decodes the bit stream in an antenna port-specific way.

For the first embodiment the UE does this after symbol-to-bit mapping and before channel decoding. Namely the UE will descramble the received bits with the antenna-port specific scrambling sequence.

For the second embodiment the UE will do this after channel decoding when checking the CRC. Namely the UE will mask the CRC that is calculated based on the decoded DCI payload with the antenna port ID, in addition to the UE ID (C-RNTI). If the CRC matches with the received CRC, the UE determines that the DCI was intended for it, and then also verifies the antenna port used for transmission. It is considered extremely unlikely that the UE would find a matching CRC with an incorrect mask (a mis-detection arising from an incorrect assumption on the antenna port ID). Document R1-080944 referenced above provides simulation results that put such a probability of CRC false detection in the range of 10⁻⁷ to 10⁻⁵.

For the third embodiment the UE will re-arrange the bits before channel decoding according to the antenna port-specific bit ordering.

For the fourth embodiment, before descrambling and decoding the UE will map the symbols to bits according to the antenna port-specific constellation mapping. For each of the first, third and fourth embodiments, the UE verifies the antenna port if the UE obtains a matching CRC since in these embodiments it is extremely unlikely to get a matching CRC from the wrong antenna port.

For the fifth embodiment, after finding the DCI the UE will verify the antenna port based on the explicit signaling bit which is in the DCI payload.

For both the eNB and for the UE, any suitable combinations of the above five embodiments can also be employed in practical implementations of these teachings. However it may not be necessary to do so since any individual embodiment should be sufficient to avoid any antenna port ambiguities and mis-detection of the E-PDCCH as a result.

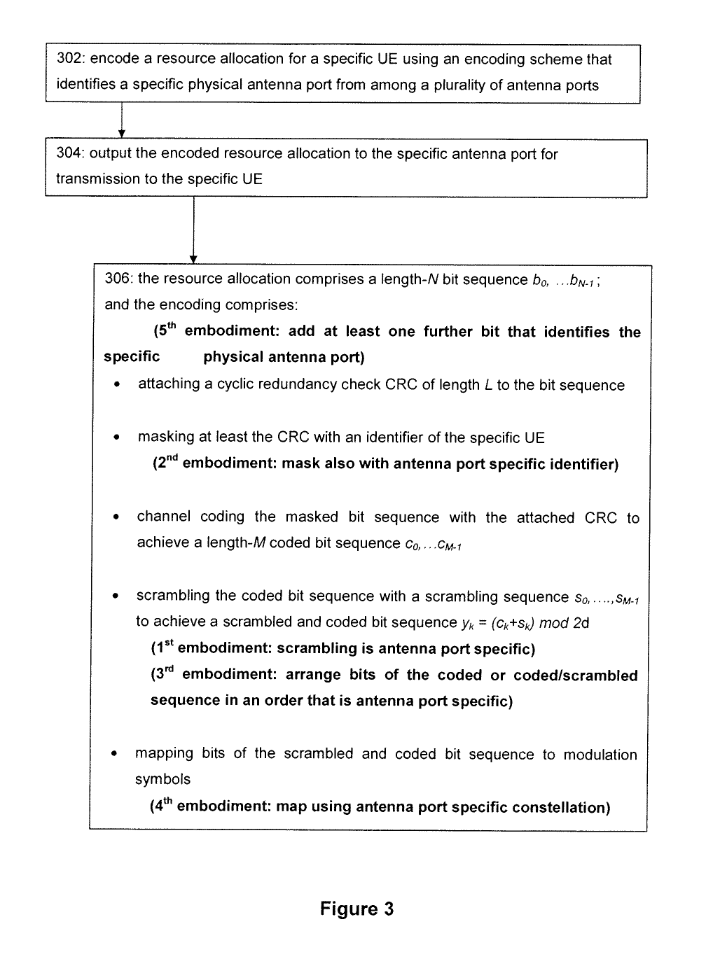

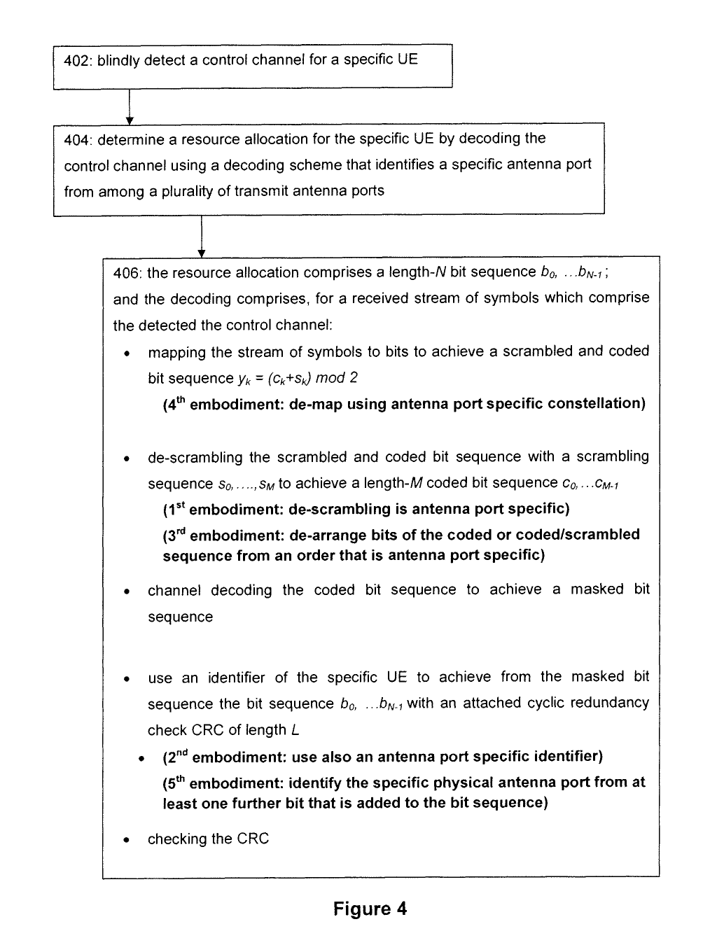

Now are detailed with reference to FIGS. 3-4 further particular exemplary embodiments from the perspective of the network/eNB and of the UE, respectively. FIG. 4 may be performed by the whole eNB, or by one or several components thereof such as a modem, a processor in combination with a program stored on a memory, etc. At block 302 a resource allocation is encoded for a specific UE using an encoding scheme that identifies a specific (logical) antenna port from among a plurality of antenna ports. Then at block 304 the encoded resource allocation is output to the specific antenna port for transmission to the specific user equipment.

Block 306 of FIG. 3 summarizes the specific but non-limiting embodiments detailed above. If we represent the resource allocation as detailed above by a length-N bit sequence b₀, . . . b_{N-1}, then the encoding comprises:
a) attaching a cyclic redundancy check CRC of length L to the bit sequence;
b) masking at least the CRC with an identifier of the specific user equipment;
c) channel coding the masked bit sequence with the attached CRC to achieve a length-M coded bit sequence c₀, . . . c_{M-1};
d) scrambling the coded bit sequence with a scrambling sequence s₀, . . . , s_{M-1} to achieve a scrambled and coded bit sequence yₖ=(cₖ+sₖ) mod 2; and
e) mapping bits of the scrambled and coded bit sequence to modulation symbols In the above encoding N, L and M are each integers greater than one.

For the first embodiment detailed above, the encoding scheme that identifies the specific antenna port comprises the scrambling, where the scrambling sequence is initiated with a value that depends on the specific antenna port. For the second embodiment it is the masking, where the bit sequence is masked with the identifier of the specific UE and with an identifier of the UE-specific logical antenna port. For the third embodiment it is arranging the bits of the coded bit sequence c₀, . . . c_{M-1} or of the scrambled and coded bit sequence yₖ=(cₖ+sₖ) mod 2 in an order which identifies the specific antenna port. This arranging includes interleaving but is not limited only to interleaving. For the fourth embodiment the encoding scheme that identifies the specific antenna port is the mapping, where the bits of the scrambled and coded bit sequence are mapped to modulation symbols according to a mapping constellation associated only with the specific physical antenna port. And for the fifth embodiment the encoding scheme that identifies the specific antenna port comprises adding to the length-N bit sequence b₀, . . . b_{N-1} at least one further bit that identifies the specific antenna port. In this case the CRC is attached to the bit sequence with the at least one further bit; and the bit sequence with the further bit(s) is masked, rather than the attaching and masking being only on the length-N bit sequence b₀, . . . b_{N-1}.

For the case in which it is the entire eNB (or more generically a network access node) rather than only one or more components performing the steps shown at FIG. 3 which may simply output at block 304 to another portion of the eNB, the eNB also transmits the encoded resource allocation as an E-PDCCH to the specific UE from an antenna associated with the specific antenna port.

Turning to FIG. 4 which details from the perspective of the UE, it may be performed by the whole UE, or by one or several components thereof such as a modem, a processor in combination with a program stored on a memory, etc. At block 402 a control channel for a specific UE is blindly decoded, and at block 404 a resource allocation for the specific UE is determined by decoding the control channel using a decoding scheme that identifies a specific antenna port from among a plurality of transmit antenna ports.

Block 406 of FIG. 4 summarizes the specific but non-limiting embodiments detailed above. If we again represent the resource allocation as a length-Nbit sequence b₀, . . . b_{N-1}; then the decoding comprises, for a received stream of symbols which comprise the detected the control channel:
a) mapping the stream of symbols to bits to achieve a scrambled and coded bit sequence yₖ=(cₖ+sₖ) mod 2;
b) de-scrambling the scrambled and coded bit sequence with a scrambling sequence s₀, . . . , sₘ₋₁ to achieve a length-M coded bit sequence c₀, . . . c_{M-1};
c) channel decoding the coded bit sequence to achieve a masked bit sequence;
d) use an identifier of the specific UE to achieve, from the masked bit sequence, the bit sequence b₀, . . . b_{N-1} with an attached CRC of length L; and
e) checking the CRC.
   As with FIG. 3, for FIG. 4 also N, L and M are each integers greater than one.

For the first embodiment detailed above, the decoding scheme that identifies the specific antenna port comprises the de-scrambling, where the scrambling sequence is initiated with a value that depends on the specific antenna port. For the second embodiment above it is obtaining or achieving the bit sequence b₀, . . . b_{N-1} with an attached CRC of length L from the masked bit sequence. The masked bit sequence need not be entirely masked, and in some embodiments only the CRC which is attached to the N-length bit sequence is masked. In the above examples the CRC may be masked with the UE identifier, with or without also an identifier of the specific antenna port. In one embodiment the CRC is de-masked using one or both of those identifiers as the case may be. In another embodiment the UE takes the payload, computes the CRC, masks that computed CRC using one or both of those identifiers as the case may be, then compares the two masked CRCs to one another to perform step e) of block 406. For the third embodiment it is de-arranging, prior to the channel decoding, the bits of the coded bit sequence c₀, . . . c_{M-1} or of the scrambled and coded bit sequence yₖ=(cₖ+sₖ) mod 2 from an order which identifies the specific antenna port. For the fourth embodiment it is the de-mapping, where the stream of symbols are mapped to bits according to a mapping constellation associated only with the specific antenna port. And for the fifth embodiment the decoding scheme that identifies the specific antenna port comprises identifying the specific antenna port from at least one further bit that is added to the length-N bit sequence b₀, . . . b_{N-1}.

For the case in which it is the whole UE which performs the steps shown at FIG. 4 rather than one or more components thereof, the UE receives the control channel as an E-PDCCH from a network access node.

The logic flow diagrams of FIGS. 3-4 may each be considered to illustrate the operation of a method, and a result of execution of a computer program stored in a computer readable memory, and a specific manner in which components of an electronic device are configured to cause that electronic device to operate. The various blocks shown in either of FIG. 3 or 4 may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

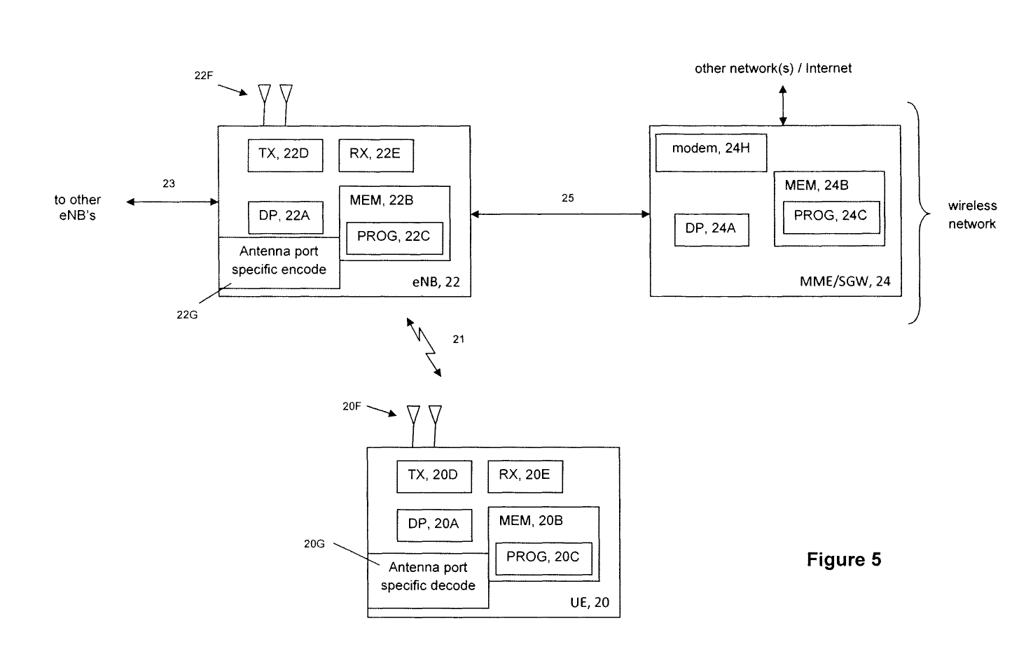

Reference is now made to FIG. 5 for illustrating a simplified block diagram of various electronic devices and apparatus that are suitable for use in practicing the exemplary embodiments of this invention. In FIG. 5 an eNB 22 is adapted for communication over a wireless link 21 with a mobile radio apparatus termed generically as a UE 20. The eNB 22 may be any access node (including frequency selective repeaters) of any type of radio access technology network such as LTE, LTE-A, WCDMA, and the like. The operator network of which the eNB 22 is a part may also include a network control element such as a mobility management entity MME and/or serving gateway SGW 24 which provides connectivity with further networks (e.g., a publicly switched telephone network and/or a data communications network/Internet).

The UE 20 includes processing means such as at least one data processor (DP) 20A, storing means such as at least one computer-readable memory (MEM) 20B which tangibly stores at least one computer program (PROG) 20C or other set of executable instructions, and communicating means such as a transmitter TX 20D and a receiver RX 20E for bidirectional wireless communications with the eNB 22 via one or more antennas 20F. Also stored in the MEM 20B at reference number 20G are the rules or algorithm for decoding the control channel (E-PDCCH) in a manner specific for an antenna port of the transmitting eNB 22 as detailed above in multiple but non-limiting embodiments.

The eNB 22 also includes processing means such as at least one data processor (DP) 22A, storing means such as at least one computer-readable memory (MEM) 22B that tangibly stores at least one computer program (PROG) 22C or other set of executable instructions, and communicating means such as a transmitter TX 22D and a receiver RX 22E for bidirectional wireless communications with the UE 20 via one or more antennas 22F. The eNB 22 stores at block 22G similar rules or algorithm for encoding the control channel (E-PDCCH) in a manner specific for an antenna port of the transmitting eNB 22 as detailed above in multiple but non-limiting embodiments.

For completeness, the MME 24 is also shown to have a processor DP 24A, a memory 24B storing a program 24C and a modem 24H for digitally modulating and demodulating information it communicates over the data and control link 25 with the eNB 22.

While not particularly illustrated for the UE 20 or eNB 22, those devices are also assumed to include as part of their wireless communicating means a modem and/or a chipset which may or may not be inbuilt onto an RF front end chip within those devices 20, 22 that may also carry the TX 20D/22D and the RX 20E/22E.

At least one of the PROGs 20C in the UE 20 is assumed to include a set of program instructions that, when executed by the associated DP 20A, enable the device to operate in accordance with the exemplary embodiments of this invention, as detailed above for FIG. 4. The eNB 22 also has software stored in its MEM 22B to implement aspects of these teachings relevant to it as detailed above for FIG. 3. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire devices as depicted at FIG. 5 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances, as well as the machine-to-machine type devices mentioned above.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE and LTE-A system, as noted above the exemplary embodiments of this invention may be used with various other wireless communication systems which have non-static antenna ports for transmitting a control channel to specific UEs.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

The following abbreviations used in the above description and/or in the drawing figures are defined as follows:

3GPP third generation partnership project

CRC cyclic redundancy check

C-RNTI cell radio network temporary identifier

CRS common reference signal

DCI downlink control information

DL downlink

eNB node B/base station in an E-UTRAN system

E-PDCCH enhanced PDCCH

E-UTRAN evolved UTRAN (LTE)

LTE long term evolution (also known as E-UTRAN)

MIMO multiple-input multiple-output

MU-MIMO multi user multiple-input multiple-output

OFDM orthogonal frequency division multiplexing

PBCH physical broadcast channel

PDCCH physical downlink control channel

PDSCH physical downlink shared channel

PUCCH physical uplink control channel

PRB physical resource block

QPSK quadrature phase shift keying

RE resource element

RS reference signal

R-PDCCH relay PDCCH

SU-MIMO single user multiple-input multiple-output

UE user equipment

UL uplink

UTRAN universal terrestrial radio access network

1. A method comprising:
encoding a resource allocation for a specific user equipment using an encoding scheme that identifies a specific antenna port from among a plurality of antenna ports; and
outputting the encoded resource allocation to the specific antenna port for transmission to the specific user equipment.

2. The method according to claim 1, in which the resource allocation comprises a length-N bit sequence b0, . . . bN−1;
and the encoding comprises:
attaching a cyclic redundancy check CRC of length L to the bit sequence;
masking at least the CRC with an identifier of the specific user equipment;
channel coding the masked bit sequence with the attached CRC to achieve a length-M coded bit sequence c0, . . . cM−1;
scrambling the coded bit sequence with a scrambling sequence s0, . . . , sM−1 to achieve a scrambled and coded bit sequence yk=(ck+sk) mod 2; and
mapping bits of the scrambled and coded bit sequence to modulation symbols;
in which N, L and M are each integers greater than one.

3. The method according to claim 2, in which the encoding scheme that identifies the specific antenna port comprises the scrambling, in which the scrambling sequence is initiated with a value that depends on the specific antenna port.

4. The method according to claim 2, in which the encoding scheme that identifies the specific antenna port comprises the masking, in which at least the CRC is masked with the identifier of the specific user equipment and with an identifier of the specific antenna port.

5. The method according to claim 2, in which the encoding scheme that identifies the specific antenna port comprises arranging the bits of the coded bit sequence c0, . . . cM−1 or of the scrambled and coded bit sequence yk=(ck+sk) mod 2 in an order which identifies the specific antenna port.

6. The method according to claim 2, in which the encoding scheme that identifies the specific antenna port comprises the mapping, in which the bits of the scrambled and coded bit sequence are mapped to modulation symbols according to a mapping constellation associated only with the specific antenna port.

7. The method according to claim 2, in which the encoding scheme that identifies the specific antenna port comprises adding to the length-N bit sequence b0, . . . bN−1 at least one further bit that identifies the specific antenna port;
and in which the CRC is attached to the bit sequence with the added at least one further bit.

8. The method according to claim 1, in which the method is executed by a network access node which transmits the encoded resource allocation as an enhanced physical downlink control channel E-PDCCH to the specific user equipment with the specific antenna port.

9. An apparatus comprising:
at least one processor and at least one memory storing a computer program;
in which the at least one memory with the computer program is configured with the at least one processor to cause the apparatus to perform at least:
encoding a resource allocation for a specific user equipment using an encoding scheme that identifies a specific antenna port from among a plurality of antenna ports; and
outputting the encoded resource allocation to the specific antenna port for transmission to the specific user equipment.

10. The apparatus according to claim 9, in which the resource allocation comprises a length-N bit sequence b0, . . . bN−1;
and the encoding comprises:
attaching a cyclic redundancy check CRC of length L to the bit sequence;
masking at least the CRC with an identifier of the specific user equipment;
channel coding the masked bit sequence with the attached CRC to achieve a length-M coded bit sequence c0, . . . cM−1,
scrambling the coded bit sequence with a scrambling sequence s0, . . . , sM−1 to achieve a scrambled and coded bit sequence yk=(ck+sk) mod 2; and
mapping bits of the scrambled and coded bit sequence to modulation symbols;
in which N, L and M are each integers greater than one.

11. The apparatus according to claim 10, in which the encoding scheme that identifies the specific antenna port comprises the scrambling, in which the scrambling sequence is initiated with a value that depends on the specific antenna port.

12. The apparatus according to claim 10, in which the encoding scheme that identifies the specific antenna port comprises the masking, in which at least the CRC is masked with the identifier of the specific user equipment and with an identifier of the specific antenna port.

13. The apparatus according to claim 10, in which the encoding scheme that identifies the specific antenna port comprises arranging the bits of the coded bit sequence c0, . . . cM−1 or of the scrambled and coded bit sequence yk=(ck+sk) mod 2 in an order which identifies the specific antenna port.

14. The apparatus according to claim 10, in which the encoding scheme that identifies the specific antenna port comprises the mapping, in which the bits of the scrambled and coded bit sequence are mapped to modulation symbols according to a mapping constellation associated only with the specific antenna port.

15. The apparatus according to claim 10, in which the encoding scheme that identifies the specific antenna port comprises adding to the length-N bit sequence b0, . . . bN−1 at least one further bit that identifies the specific antenna port; in which the CRC is attached to the bit sequence with the added at least one further bit

16. The apparatus according to claim 9, in which the apparatus comprises a network access node which is configured to transmit the encoded resource allocation as an enhanced physical downlink control channel E-PDCCH to the specific user equipment from an antenna associated with the specific antenna port.

17. A computer readable memory tangibly storing a computer program executable by at least one processor, the computer program comprising:
code for encoding a resource allocation for a specific user equipment using an encoding scheme that identifies a specific antenna port from among a plurality of antenna ports; and
code for outputting the encoded resource allocation to the specific antenna port for transmission to the specific user equipment.

18. The computer readable memory according to claim 17, in which the resource allocation comprises a length-N bit sequence b0, . . . bN−1;
and the code for encoding comprises:
code for attaching a cyclic redundancy check CRC of length L to the bit sequence;
code for masking at least the CRC with an identifier of the specific user equipment;
code for channel coding the masked bit sequence with the attached CRC to achieve a length-M coded bit sequence c0, . . . cM−1;
code for scrambling the coded bit sequence with a scrambling sequence s0, . . . , sM−1 to achieve a scrambled and coded bit sequence yk=(ck+sk) mod 2; and
code for mapping bits of the scrambled and coded bit sequence to modulation symbols;
in which N, L and M are each integers greater than one.

19-36. (canceled)
